(19) United States
(12) Patent Application Publication
(10) Pub. No.: US 2010/0042618 A1
(43) Pub. Date: Feb. 18, 2010

(54) SYSTEMS AND METHODS FOR COMPARING USER RATINGS

(76) Inventors: Peter Rinearson, Vashon, WA (US); Wistar Rinearson, Redmond, WA (US)

Correspondence Address: STOEL RIVES LLP - SLC, 201 SOUTH MAIN STREET, SUITE 1100, ONE UTAH CENTER, SALT LAKE CITY, UT, 84111, US

(21) Appl. No.: 12/540,287

(22) Filed: Aug. 12, 2009

Related U.S. Application Data
(60) Provisional application No. 61/088,305, filed on Aug. 12, 2008.

(51) Int. Cl. G06F 17/30

(52) U.S. Cl. 707/5; 707/E17.017

(57) ABSTRACT

A rating submitted by a user may be compared to ratings submitted by other users in a user community. The users within the user community may be identified using respective descriptive tags. A subset of users within the community may be defined using the descriptive tags. A tag-specific comparison may be made between the rating submitted by the user and a particular subset of the user community. The user may add, edit, and/or remove descriptive tags responsive to the comparisons. Cohesive groups may be identified within the user community. Ratings submitted by members of a cohesive group may be used to suggest content to other members of the group.

### CROSS-REFERENCE TO RELATED APPLICATIONS

This application claims the benefit of U.S. Provisional Application No. 61/088,305, filed Aug. 12, 2008, which is fully incorporated herein by reference.

### TECHNICAL FIELD

This disclosure relates to systems and methods for comparing a rating to one or more user community ratings.

### SUMMARY OF THE INVENTION

Users in a user community may be identified using respective descriptive tags. Ratings submitted by a user may be compared to ratings submitted by the user community. One or more descriptive tags may be specified to make a tag-specific rating comparison. A subset of users may be selected from the user community using specified descriptive tags. The rating submitted by the user may be compared to the ratings submitted by the users in the subset, as opposed to comparing the rating to the user community as a whole.

An interface may be provided to display the results of the comparison. The interface may include one or more statistical properties of the ratings submitted by the users within the subset. The rating submitted by the user may be compared to the statistical properties of the subset, such as a rating mean and/or rating deviation. The comparison may include a graphic. The graphic may include a plot of the ratings submitted by the users in the subset. The rating submitted by the user may be displayed on the plot.

The user subset may be defined as the users that have one or more of the specified descriptive tags. Alternatively, or in addition, the subset may be defined as the users within the user community that do not have one or more of the specified descriptive tags. Similarly, a subset may be identified as users within the user community that have a first one of the specified tags, and do not have second one of the specified descriptive tags.

One or more potential descriptive tags for the user may be identified based upon the rating submitted by the user. The potential descriptive tags may be selected by identifying one or more community users that submit ratings similar to those submitted by the user (e.g., based on a single rating or a plurality of ratings). The descriptive tags of the identified users may be selected as the potential descriptive tags for the user.

The user may submit a plurality of different ratings of different items. Each of the plurality of ratings may be compared to ratings submitted by users within the identified subset of the user community. The results of the comparisons may be displayed to the user.

A cohesive group may be identified within the user community. Ratings submitted by the members of the cohesive group may be used to suggest content for other members of the group. A group may be defined as two or more users that share a common set of descriptive tags. A cohesive group may be identified by comparing the ratings submitted by the members of the group. A high correlation between ratings submitted by the group members may be indicative that the group is cohesive. The ratings of group members may be used to identify content for the group; content that is favorably rated by some members of the group may be suggested to other members of the group.

### BRIEF DESCRIPTION OF THE DRAWINGS

FIG. 1 is a flow diagram of a method for comparing a user rating to community user ratings;

FIG. 2 is a block diagram of a system for comparing a user rating of a content item to one or more community user ratings;

FIG. 3 depicts one embodiment of a rating comparison interface;

FIG. 4 is a graphical depiction of a rating comparison; and

FIG. 5 is a graphical depiction of a rating comparison.

### DETAILED DESCRIPTION OF PREFERRED EMBODIMENTS

Websites featuring user-contributed content have become very popular and are among the fastest growing websites on the Internet. Many of these websites rely on the quality of the content submitted by their respective user communities to attract and retain users. As such, these websites may wish to induce their users to submit high-quality content.

As used herein, submissions to a website by a user of the website may be referred to as “content” and/or a “content item.” As used herein, content submitted to a website may include, but is not limited to: an image, an illustration, a drawing, pointer (e.g., a link, uniform resource indicator (URI), or the like), video content, Adobe Flash® content, audio content (e.g., a podcast, music, or the like), text content, a game, downloadable content, metadata content, a blog post or entry, a collection and/or arrangement of content items, or any other user-authored content. In addition, a content item may include, but is not limited to: a text posting in a threaded or unthreaded discussion or forum, a content item (as defined above) posting in a threaded or unthreaded discussion, a user-submitted message (e.g., forum mail, email, etc.), or the like.

As used herein, a website may refer to a collection of renderable content comprising images, videos, audio, and/or other digital assets that are accessible by a plurality of users over a network. A website may be published on the Internet, a local area network (LAN), a wide area network (WAN), or the like. As such, a website may comprise a collection of webpages conforming to a rendering standard, such as hypertext markup language (HTML), and may be renderable by a browser, such as Microsoft Internet Explorer®, Mozilla Firefox®, Opera®, or the like. However, other markup languages (e.g., Portable Document Format (PDF), extensible markup language (XML), or the like) and/or other display applications (e.g., a custom software application, a media player, etc.) may be used under the teachings of this disclosure. In addition, as used herein, a website may refer to a content provider service, such as a photo service (e.g., iStockphoto®, Getty Images®, etc.), a news service (e.g., Reuters, Associated Press, etc.), or the like.

Although the term “website” is used as a singular term herein for clarity, the disclosure is not limited in this regard. A website could refer to a collection of a plurality of websites. Moreover, as used herein, a “user,” may refer to a user identity on a particular website and/or a user identity that may span multiple websites. A “user,” therefore, may refer to a “user account” on a particular website and/or a user identity that may be independent of any particular website, such as a Google® Account, a Microsoft Passport identity, a Windows Live ID, a Federated Identity, an OpenID® identity, or the like. Accordingly, a user and/or a “user community” as used herein may refer to a collection of users within a single website and/or a collection of users that may span multiple websites or services.

In some embodiments, a website may encourage quality submissions by allowing other users to rate and/or critique user-contributed content. The ratings may be “overall” ratings of the content and/or may include ratings of particular aspects or categories of the content (e.g., “subject appeal,” “technical merit,” and so on). User-submitted ratings may be displayed in connection with the content. In some embodiments, the user-submitted ratings may be combined into one or more “aggregate” ratings of the content. The aggregate rating(s) may be displayed in connection with the content item. The submitter of the content may want to be sure that his or her content is highly rated and, as such, may be motivated to submit quality work to the website.

In some embodiments, highly-rated content may receive more attention on the website than lower-rated content. As such, the highly-rated content may “represent” the website in the sense that users may judge the quality of the content available through the website based on the highly-rated content featured thereon. The website may prominently feature highly-rated content on a “home” or “portal” page, on website advertising banners, or the like. New users accessing the website may be presented with the featured, highly-rated content and become interested in exploring the other content available on the site. Similarly, inbound links to the website may feature the highly-rated content, which, in turn, may increase traffic to the site. As such, the highly-rated content may act as an effective form of advertisement for the website to grow the website's community user-base.

The website may be further configured to aggregate related content (e.g., into an “arena” comprising a collection of content items). Systems and methods for aggregating content items are provided in co-pending application Ser. No. ______ (attorney docket No. 38938/14), filed on Aug. 12, 2009, and entitled “Systems and Methods for Aggregating Content on a User-Content Driven Website,” which is hereby incorporated by reference in its entirety. The aggregated content may be provided to users of the website (e.g., may be highlighted on the website), may be provided responsive to a search query or an inbound link, or the like. The selection of the content to be highlighted on the website and/or to be included in a particular aggregation may be based in part upon the user-submitted ratings of the content.

In some embodiments, the website may be configured to provide inducements to reward users who submit high-quality content. These inducements may comprise monetary rewards, credits for use on the website (e.g., storage space for user-submitted content, etc.), and the like. Similarly, the inducements may be related to a user's reputation on the website. For example, a user may be assigned a “user rating,” which may be derived from the ratings of content submitted by the user. A high-user rating may indicate that the user has consistently submitted high-quality content to the website. The user rating may be displayed in connection with user's activities on the website (e.g., in connection with content submitted by the user, posts made by the user, in a user profile of the user, and so on). Accordingly, other users of the website may be provided an easy-to-digest indication of the nature of the user's contributions to the site. In some embodiments, user rating information may be provided via user-contributor rating index information. Systems and method for calculating and/or displaying user rating information are described in co-pending Ser. application No. ______ (attorney docket No. 38938/11), filed Aug. 12, 2009, and entitled “Systems and Methods for Calculating and Presenting a User-Contributor Rating Index,” which is hereby incorporated by reference in its entirety.

The quality of the user-ratings may, therefore, be of significant importance to the success of the website; accurate user ratings may allow the website to: identify content to highlight on the website (e.g., for prominent display on the website, to display responsive to inbound links, for aggregation into a particular arena, or the like); provide user feedback and inducement to submit quality work; provide a user reputation system (e.g., via a user rating); and the like.

In addition, user ratings may provide insight into the rater himself/herself. For example, a user may be interested in knowing how his or her rating of a particular content item compares to ratings submitted by other users. This may give the user an idea of how his or her opinion compares with the opinions of other users. Comparisons of ratings submitted by various users may reveal shared tastes, preferences, and other commonalities between users.

In some embodiments, a user may be associated with one or more descriptive tags. As used herein, a tag used to describe a user may be referred to as a “descriptive tag,” “user tag,” or “tag.” A descriptive tag may be supplied by the user, may be provided by the website (e.g., by an employee, administrator, or the like), may be automatically generated, may be applied by other users, or applied from some other source. A descriptive tag may be used to categorize and/or describe the user. For example, a male user who is relatively young and works as an artist may apply “male,” “young,” and “artist” tags to himself.

Descriptive tags may be used describe any aspect and/or characteristic of a user, including, but not limited to: the user's political persuasion (e.g., “liberal”), the user's belief system (e.g., “agnostic”), education level, profession, physical characteristic, race, value system, sexual preference (e.g., gay, straight, bi-sexual), and so on. Descriptive tags may be indicative of the content authored and/or submitted by the user; such tags may indicate the quality, nature, school, style, quantity, and the like of the user's corpus. Descriptive tags may also be indicative of the user's activities on the website and/or the user's interactions with the user community; such tags may indicate the nature of ratings submitted by the user (e.g., as a rating weight, a “low rater” tag, a “generous rater” tag, or the like), the nature of the user's commentary and/or critiques (e.g., a “cantankerous” tag, “volatile” tag, “friendly” tag, and so on). The systems and methods disclosed herein may be adapted to use any set of tags describing any user characteristic and/or preference. Accordingly, this disclosure should not be read as limited in this regard.

As discussed above, a certain descriptive tags may be applied by the website. Some website-applied tags may be automatically applied once a user meets certain criteria. For example, a “high-level contributor” tag may be applied to a user based on the amount of content authored and/or submitted by the user. Therefore, once the user has authored and/or submitted a threshold amount of content, the “high-level contributor” tag may be automatically applied to the user. Alternatively, or in addition, personnel associated with the website may manually apply various tags (e.g., website administrators, moderators, domain experts, or the like).

Other descriptive tags may be applied by other users (e.g., the user community). For example, a “highly rated” tag may be applied to a user whose content submissions are consistently highly-rated by other members of the user community. The “highly rated” tag may be applied when certain criteria are met (e.g., when the aggregate rating of content authored by the user exceeds a threshold). Alternatively, community users may be given the opportunity to “vote” for and/or select from a group of qualifying users those users who should be given the “highly rated” tag.

When rating a particular content item, users may be interested in knowing, not only how their rating compares with the ratings submitted by other community users, but also how they compare to other users that have a particular set of descriptive tags. For example, a user may wish to see how his or her rating compares to the ratings submitted by “young” user (e.g., have a “young” tag), and so on.

In addition, comparing ratings based upon user tag information may provide users with insight into their own personality, preferences, and/or style, even if the user is not aware of such. For example, a user may compare his/her ratings with ratings of other user's having different descriptive tags. By so doing, the user may discover that he/she rates content similarly to users who have a particular set of user tags. For instance, a user who has applied descriptive tags “young” and “artist” to himself may find that he rates content similarly to users who have a “corporate” descriptive tag. This may provide insight into aspects of the user's personality, of which even the user may be unaware.

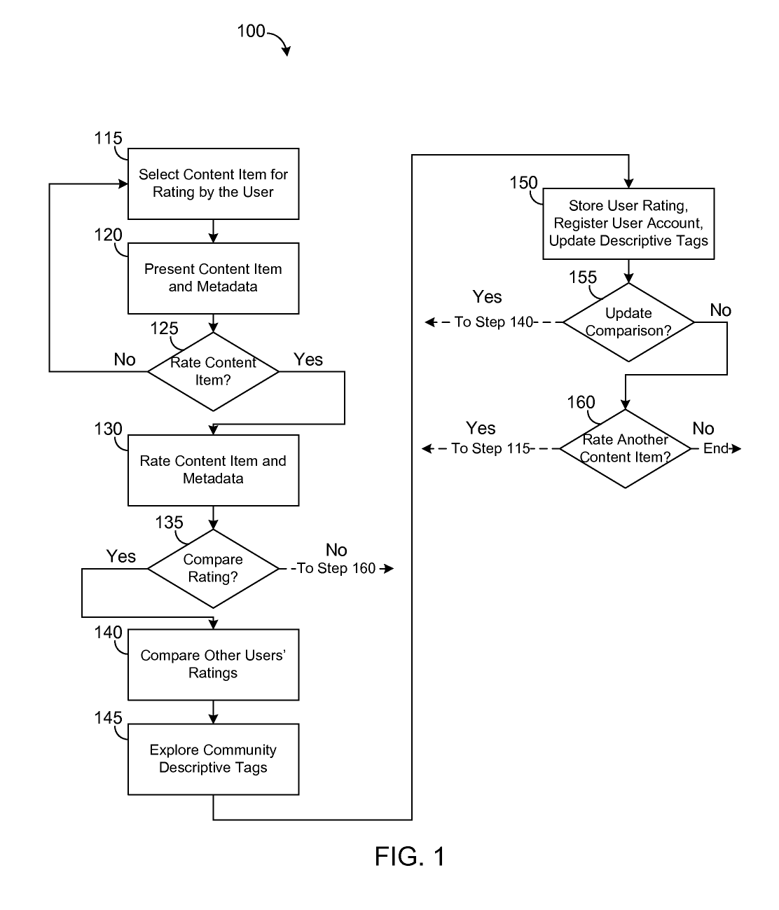

FIG. 1 depicts a flow diagram of one embodiment of a method 100 for comparing a user rating to community user ratings. The comparison may be based upon descriptive tags associated with the rating submitters. The rating comparison may be referred to herein as an “opinion game.” The method 100 may comprise one or more machine executable instructions stored on a computer-readable storage medium. The instructions may be configured to cause a machine, such as a computing device, to perform the method 100. In some embodiments, the instructions may be embodied as one or more distinct software modules on the storage medium. One or more of the instructions and/or steps of method 100 may interact with one or more hardware components, such as computer-readable storage media, communications interfaces, or the like. Accordingly, one or more of the steps of method 100 may be tied to particular machine components.

At step 115, the method 100 may select a content item for rating by a user. In some embodiments, the content item of step 115 may be randomly selected. Alternatively, the content item may be selected based upon one or more descriptive tags associated with the user (e.g., based on whether the user applied an “artist” tag to himself). The selection of step 115 may be configured to prevent selection of content items that have been previously viewed and/or rated by the user. This may prevent re-rating of content items and/ or presenting content items for rating to which the user has already been exposed.

In some embodiments, the selection of step 115 may be adapted to provide insight into descriptive tags associated with the user. As discussed above, user-submitted ratings may be associated with the descriptive tags of the rating submitters. Raters having similar descriptive tags may submit similar ratings. Raters that have certain dissimilar tags may submit consistently divergent ratings (e.g., users that have an “urban” tag may rate items differently than users that have a “country” tag). Certain content items that highlight these differences may be identified (e.g., based upon statistical analysis of the user-submitted ratings of the content items). The selection of step 115 may be adapted to select the content items that have been identified as prompting the highly divergent ratings, since the ratings of these content items may provide additional insight into the preferences of the user.

In some embodiments, the content items available for selection at step 115 may include a set of content items that have been specifically selected and/or produced to yield highly divergent reactions from different types of users. The set of content items may be arranged into a conditional sequence, such that the selection of step 115 may depend upon ratings previously submitted by the user. Therefore, each successive content item selected at step 115 (e.g., over multiple iterations of the method 100) may be adapted to explore a different preference of the user.

At step 120, the selected content item may be presented to the user. Presenting the content item at step 120 may comprise providing a user interface to display the content item. As discussed above, a content item may include various content types (e.g., imagery, video, audio, text, etc.). The interface provided at step 120 may be adapted to the type of content item selected at step 115. For example, a visual content item (e.g., an image, video content, text, etc.) may be presented to an image viewer component of the user interface, video may be presented in a media player component, and so on. The content item presented at step 120 may be associated with metadata including, but not limited to: a title, a caption, a description of the creation and/or authoring of the content item, one or more keywords or metadata tags associated with the content item, and the like. The interface provided at step 120 may be configured to display the metadata information along with the content item. The interface may further include one or more rating inputs to allow a user of the interface to submit one or more ratings of the content item and/or metadata.

At step 125, the user may elect to submit a rating of the content item and any metadata associated therewith. Alternatively, the user may elect to skip the content item and select another content item for rating. If the user selects to rate the content item, the flow may continue to step 130; otherwise, the flow may return to step 115 where another content item may be selected.

At step 130, the user may rate the content item and associated metadata using the one or more rating inputs in the interface provided at step 120. The rating inputs may include, but not limited to: a slider controls, a selection boxes, a range indicators, an alpha numeric inputs, and the like.

At step 135, the user may be presented with the option of comparing the ratings submitted at step 130 to ratings of other community users. If the user elects to compare ratings, the flow may continue at step 140; otherwise, the flow may continue to step 150.

At step 140, the user-submitted ratings of step 130 may be compared to ratings submitted by other community users. The comparison may comprise a statistical comparison, such as the percentage of community users who rated the content item and/or metadata similarly to the user, the percentage who rated the content item and/or metadata higher and/or lower than the user, and the like. In one embodiment, user community ratings may be modeled using a statistical model, such as a Normal distribution or the like. In this case, the comparison may comprise plotting the user-submitted rating on a distribution or histogram depicting the ratings submitted by the other user community users.

At step 145, the rating comparison of step 140 may be refined using descriptive tags of other users in the user community. This may allow the user to compare the rating submitted at step 130 to ratings submitted by users having particular descriptive tags. For example, a user may want to compare his/her rating with the ratings submitted by users who have: a “male” tag, a “young” tag; and/or an “artist” tag, resulting in three separate comparisons. Alternatively, or in addition, a comparison may be based on a composite of one or more descriptive tags (e.g., compared against ratings submitted by users having both “young” and “artist” descriptive tags, etc.).

The user rating comparison of step 145 may comprise comparing the rating submitted by the user at step 130 to ratings submitted by users having a particular set of tags. The descriptive tags used at 145 may or may not be associated with the user himself. The tag-specific comparisons may allow the user to compare his/her ratings to ratings submitted by users associated with different tags to explore similarities and/or differences therebetween.

As such, at step 145, the user may supply one or more descriptive tags to use as the basis of a tag-specific rating comparison. For example, although the user may be a self-described, “young,” “male,” “artist” he may wish to compare his ratings to those submitted by “female,” “young,” “artist” users. Similarly, he may wish to explore the comparison of his ratings to those submitted by users described as “corporate,” or the like. These comparisons may reveal that the user actually has more in common (from a content item and metadata ratings perspective) with users having different descriptive tags (e.g., “corporate” tagged users) than those users who have descriptive tags that are similar to his own.

In addition, at step 145, the method 100 may automatically identify user-descriptive tags with which the user exhibits a high degree of similarity (e.g., based on an automated comparison performed by the method 100). For example, a user may exhibit similar rating behavior to users associated with a particular set of descriptive tags. At step 145, the user may be informed of such via a message and/or comparison display showing the high degree of correlation. This may prompt the user to investigate users with the identified tag. In addition, the tag suggestions may provide an additional level of user introspection into descriptive tags the user did not even think to consider. In some embodiments, at step 145, a listing of particular tags may be displayed, along with the user's correlation to each of the particular tags. The comparisons with the particular tags may be performed automatically, without user intervention. This may provide an additional type of user-introspection to allow the user to explore descriptive tags he/she may not have otherwise considered. The tags selected for the automatic comparison described above may be selected from a group of poplar tags, may be selected from tags that are considered to be similar to the user's current set of tags, or the like.

At step 150, the user rating provided at step 130 may be stored in a storage location and associated with a user account (if a user account for the user exists). The storage location may comprise a computer-readable storage medium, such as a hard disc, flash memory, or the like. The data storage location may include a database, a relational database, a directory, or the like.

The user ratings may be used to establish a rating history of the user. The rating history may be used to identify groups of users (as defined by the descriptive tags of the users) that have similar rating tendencies to the user. In addition, the rating history may be used to determine a cohesiveness of a particular user-descriptive tag. For example, if the users that have a particular descriptive tag consistently rate content items similarly, the tag may be considered to be a cohesive tag. Conversely, a tag may be considered to be non-cohesive where users having the tag submit widely divergent ratings. As such, step 150 may be used to identify cohesive groups within the user community, which may be used to custom tailor content and/or advertising to particular users.

In addition, at step 150, the user may be given the option of establishing a new user account and/or modifying his/her existing user account. Establishing a user account may comprise providing a user name, password, contact information, and the like to method 100. Alternatively, a third-party identifier may be provided, such as an OpenID® identifier, Windows Live ID, or the like. The information provided at step 150 may be used to establish a user account representing the user in a website community. The user account information may be stored in a storage location and may be associated with the rating(s) submitted by the user over the course of multiple iterations of the method 100 (e.g., over the course of rating a plurality of different content items at step 130).

In addition, at step 150, the user may be allowed to associate one or more descriptive tags to his/her user account. If the user is already associated with a user account, the user may be given the opportunity to edit his/her user account to add, remove, and/or edit descriptive tags. The modification of the user's descriptive tags at step 150 may be in response to the comparisons of steps 140-145. For example, the user may discover that he/she consistently rates content similarly to users having a particular tag (e.g., “artist”). As such, the user may wish to apply the “artist” descriptive tag at step 150.

At step 155, the user may be prompted to return to the comparison step 140. The user may wish to do so to view the results of establishing a new user account and/or modifying user descriptive tags at step 150. If the user elects to update the comparison, the flow may continue at step 140; otherwise, the flow may continue to step 160.

At step 160, the user may be given the option of rating another content item. If the user chooses to rate an additional item, the flow may continue to step 115 where the next content item to rate may be selected; otherwise, the flow may terminate.

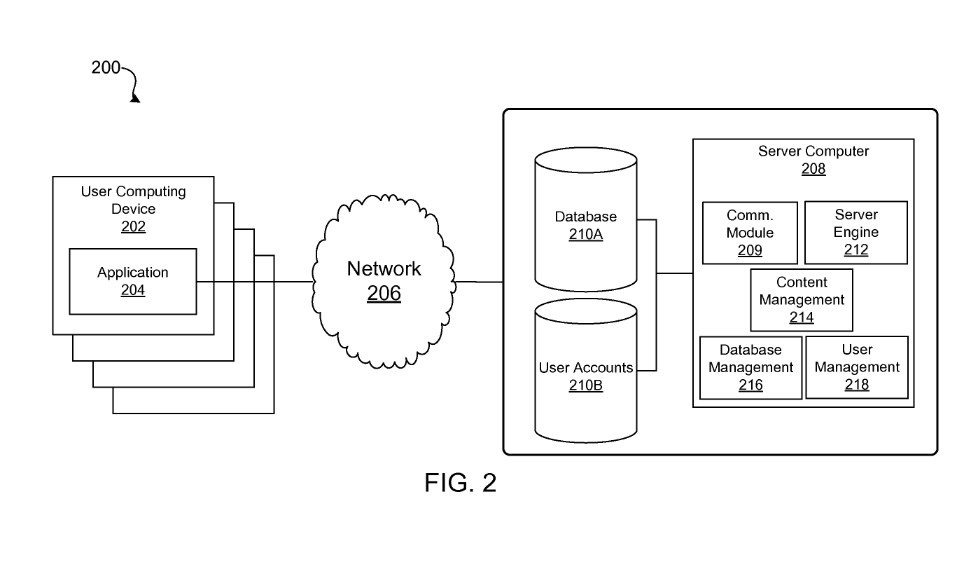

Aspects of the teachings of this disclosure may be practiced in a variety of computing environments. FIG. 2 depicts one embodiment of a system for generating, maintaining, and/or providing for displaying user-contributor rating index information. The one or more user computing devices 202 may comprise an application 204 that may be used to access and/or exchange data with other computing devices on the network 206, such as the server computer 208. The application 204 may comprise a web browser, such as Microsoft Internet Explorer®, Mozilla Firefox®, Opera®, or the like. Alternatively, or in addition, the application 204 may comprise a media player and/or content presentation application, such as Adobe Creative Suite®, Microsoft Windows Media Player®, Winamp®, or the like. The user computing device 202 and/or the application 204 may comprise a network interface component (not shown) to allow the application 204 to communicate with and/or access content made available by the server computer 208 via the network 206. For example, Adobe Creative Suite® may provide access to a stock photo repository to allow users to purchase content for integration into an Adobe® project; a media player, such as Microsoft Windows Media Player®, may provide access to an online, streaming music to allow a user to purchase audio content therefrom; and a web browser may provide access to web accessible content on the network 206.

The application 204 may allow a user to access websites or other content accessible via a Transmission Control Protocol (TCP) Internet Protocol (IP) network (i.e., a TCP/IP network). One such network is the World Wide Web or Internet. One skilled in the art, however, would recognize that the teachings of this disclosure could be practiced using any networking protocol and/or infrastructure. As such, this disclosure should not be read as limited to a TCP/IP network, the Internet, or any other particular networking protocol and/or infrastructure.

The user computing devices 202 may comprise other program modules, such as an operating system, one or more application programs (e.g., word processing or spreadsheet applications), and the like. The user computing devices 202 may be general-purpose and/or specific-purpose devices comprising a processor, memory, computer-readable storage media, input-output devices, communications interfaces, and the like. The computing devices 202 may be adapted to run various types of applications, or they may be single-purpose devices optimized or limited to a particular function or class of functions. Alternatively, the user computing devices 202 may comprise a portable computing device, such as a cellular telephone, personal digital assistant (PDA), smart phone, portable media player (e.g., Apple iPod®), multimedia jukebox device, or the like. As such, this disclosure should not be read as limited to any particular user computing device implementation and/or device interface. Accordingly, although several embodiments herein are described in conjunction with a web browser application, the use of a web browser application and a web browser interface are only used as a familiar example. As such, this disclosure should not be read as limited to any particular application implementation and/or interface.

The network 206 may comprise routing, addressing, and storage services to allow computing devices, such as the user computing devices 202 and the server computer 208 to transmit and receive data, such as web pages, text content, audio content, video content, graphic content, and/or multimedia content therebetween. The network 206 may comprise a private network and/or a virtual private network (VPN). The network 206 may comprise a client-server architecture in which a computer, such as the server computer 208, is dedicated to serving the one or more user computing devices 202, or it may have other architectures, such as a peer-to-peer, in which the one or more user computing devices 202 serve simultaneously as servers and clients. In addition, although FIG. 2 depicts a single server computer 208, one skilled in the art would recognize that multiple server computers 208 could be deployed under the teachings of this disclosure (e.g., in a clustering and/or load sharing configuration). As such, this disclosure should not be read as limited to a single server computer 208.

The server computer 208 may be communicatively coupled to network 206 by a communication module 209. The communication module 209 may comprise one or more wired and/or wireless network interfaces capable of communicating using a networking and/or communication protocol supported by the network 206 and/or the user computing devices 202.

The server computer 208 may comprise and/or be communicatively coupled to a data storage module 210A. Data storage module 210A may comprise one or more databases, XML data stores, file systems, X.509 directories, LDAP directories, and/or any other data storage and/or retrieval systems known in the art. Accordingly, the data storage module 210A may include disc storage devices (e.g., hard discs), optical storage devices, or the like. The data storage module 210A may store web pages and associated content (e.g., user submitted content) to be transmitted to one or more of user computing devices 202 over network 206.

The server computer 208 may comprise a server engine 212, a content management component 214, and a data storage management module 216. The server engine 212 may perform processing and operating system level tasks including, but not limited to: managing memory access and/or persistent storage systems of the server computer 208, managing connections to the user computing device(s) 202 over the network 206, and the like. The server engine 212 may manage connections to/from the user computing devices 202 using a communication module (not shown).

The content management module 214 may create, display, and/or otherwise provide content to user computing device(s) 202 over network 206. In addition, and as will be discussed below, the content management module 214 may manage user profile information and user-submitted content displayed to or received from user computing devices 202. Data storage management module 216 may be configured to interface with the data storage module 210A to store, retrieve, and otherwise manage data in the data storage module 210A.

In some embodiments, the server engine 212 may be configured to provide data to the user computing devices 202 according to the HTTP and/or secure HTTP (HTTPS) standards. As such, the server computer 208 may provide web page content to the user computing devices 202. Although the server computer 208 is described as providing data according to the HTTP and/or HTTPS standards, one skilled in the art would recognize that any data transfer protocol and/or standard could be used under the teachings of this disclosure. As such, this disclosure should not be read as limited to any particular data transfer and/or data presentation standard and/or protocol.

The user computing devices 202 may access content stored on the data storage module 210A and made available by a content management module 214 via a URI addressing the server computer 208. The URI may comprise a domain name indicator (e.g., www.example.com) which may be resolved by a domain name server (DNS) (not shown) in the network 206 into an Internet Protocol (IP) address. This IP address may allow the user computing devices 202 to address and/or route content requests through the network 206 to the server computer 208. The URI may further comprise a resource identifier to identify a particular content item on the server computer 208 (e.g., content.html).

Responsive to receiving a URI request, the server engine 212 may be configured to provide the content to the user computing device 202 (e.g., web page) identified in the URI. The content management module 214 and a data storage management module 216 may be configured to obtain and/or format the requested content to be transmitted to the user computing device 202 by the server engine 212.

Similarly, the server engine 212 may be configured to receive content authored and/or submitted by a user via the one or more user computing devices 202. The user-submitted content may comprise a content item, such as an image, a video clip, audio content, or any other content item. The user-submitted content may be made available to other users via the one or more user computing devices 202 via the server computer 208. User-submitted content may further include metadata, commentary, and the like. For example, users may submit ratings of content available on the server computer 208.

The server computer 208 may comprise a user management module 218. The user management module 218 may access the user account data storage module 210B, which may comprise one or more user accounts relating to one or more users authorized to access and/or submit content to the server computer 208. The user account data storage module 210B may comprise user profile information. As discussed above, a user profile may comprise a user password, content accessed by the user, content submitted by the user, ratings of the content submitted by the user, user-contributor rating index information, and the like.

The user management module 218 may provide for associations between user account information and one or more descriptive tags. As discussed above, descriptive tags may be used to describe a user. The descriptive tags of a user may be included as part of a user profile, may be linked to a user account in the data storage module 210B, or the like. The user accounts may be indexed by the descriptive tags in the data storage module 210B, which may allow the user management module 218 to search for and/or identify user accounts having particular descriptive tags. The user management module 218 may provide one or more interfaces configured to allow new users to register user accounts, allow for the modification of existing user accounts, allow for the deletion of user account information, and the like. Accordingly, the user management module 218 may allow users to add, edit, and/or remove descriptive tags.

The user management module 218 may provide for assignment of descriptive tags to various users accounts. The descriptive tags may be assigned automatically when a user satisfies a particular criteria (e.g., has submitted a certain number of content items to the website, has submitted a certain number of content item ratings, or the like). Alternatively, or in addition, descriptive tags may be added by other users, website employees, or the like. In some embodiments, tags assigned by the website and/or other users may not be modifiable by the user.

The server engine 212 may be configured to provide various interfaces to display content available on the database 201A to the user computing devices 202. The interfaces may include one or more rating inputs through which users may submit ratings of the content. The user submitted ratings may be indexed according to the users who provided the ratings. Accordingly, the user-submitted ratings may be associated with one or more descriptive tags of the rating submitters.

The user-submitted ratings may be stored in a data storage module 210A and/or 210B and made available for various rating metrics and/or rating comparisons. The ratings may be indexed using the descriptive tags of the rating submitters. In some embodiments, the tags of a particular user may be applied to the ratings submitted by the user. As such, a user-submitted rating may “inherit” the descriptive tags of the submitter. The ratings submitted by a user may be associated with a respective user account (e.g., in the user account data store 210B and/or the database 210A). The associations may allow the ratings of a particular user to be quickly identified and/or accessed.

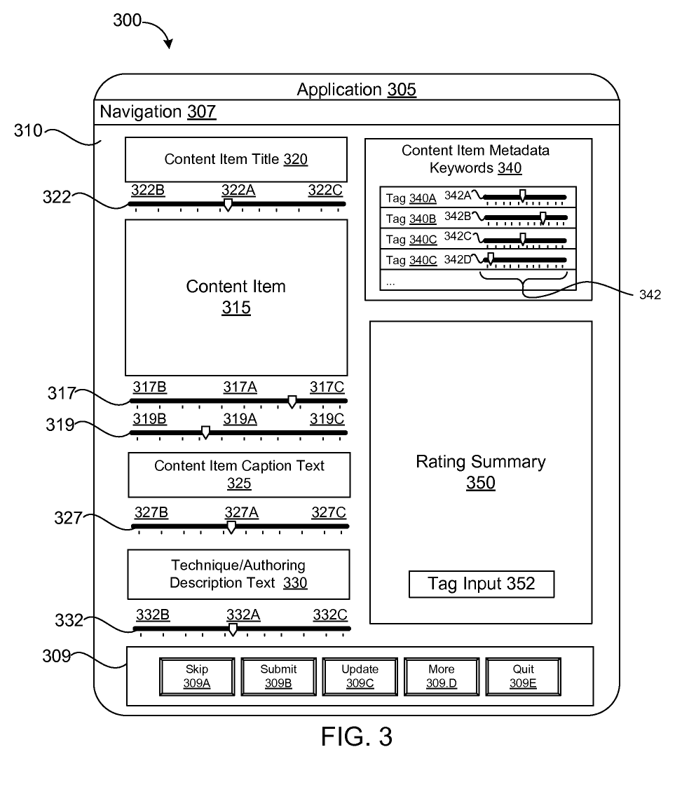

The content management module 214 may use the ratings to generate various rating metrics (e.g., rating distributions, histograms, etc.). In addition, the ratings may be used to make various ratings comparisons. In some embodiments, the content management module 214 may be configured to provide a sequence of rated content items to a user (e.g., provide a rating comparison interface and/or an opinion game). The ratings submitted as part of the opinion game may be used to make tag-based rating comparisons as described above in conjunction with method 100 of FIG. 1. One example of an interface configured to provide tag-based rating comparisons is described below in conjunction with FIG. 3.

The tags associated with the ratings may be used to identify cohesive groups of users or “tag groups” within a user community. As used herein, a “tag group” may be a group of one or more users that share a similar set of descriptive tags. For example, a set of users may share the “young,” “artistic,” and “urban” descriptive tags. Accordingly, membership in the tag user group may be defined by whether a user is assigned the “young,” “artistic,” and “urban” descriptive tags.

The user management module 218 may identify a tag group by comparing the tags applied to various user accounts. A tag group may be identified as a “cohesive” tag group based on the ratings submitted by the members of the tag group. If the ratings correspond to one another (e.g., are highly correlated), the tag group may be identified as cohesive. Accordingly, content that is highly rated by certain members of the tag group may be identified as content that is likely to be of interest to other users of the tag group (e.g., other users that share tags that define the tag group). In this way, the content management module 214 and/or the user management module 218 may suggest content that may be of interest to various users based on the users' descriptive tags. Similarly, advertising and/or other related content may be provided to the users based on the users' descriptive tags.

The tag group-based content suggestions described above may be extended to users who share some, but not all of the tags of a particular group. For example, a user who has the tags “young” and “urban,” but not the “artistic” tag, may be provided with content suggestions relevant to the “young,” “artistic,” and “urban” tags. In addition, the user may provide feedback (via a rating comparison, such as method 100) to determine whether he or she should add the “artistic” tag. For example, if the user determines that he or she rates content similarly to the users in the “young,” “artistic,” and “urban” tag group, the user may be prompted to add the relevant tags.

Tag rating comparisons may be leveraged to identify potential tags for the user. For instance, a set of ratings submitted by a user may be compared to ratings submitted by users having a different set of descriptive tags. If the ratings are highly correlated, the user may be prompted to consider adding the descriptive tags to his or her profile. For example, if the ratings submitted by a user are highly correlated to ratings submitted by users having “young,” “artistic,” and “liberal,” tags, the user may be prompted to add one or more of the “young,” “artistic,” and/or “liberal” tags.

FIG. 3 depicts one embodiment of a rating comparison interface 300 (e.g., an opinion game interface) displayed in an application 305 comprising a navigation component 307 and display area 310. The application 305 may comprise web browser software, such as Microsoft Internet Explorer®, Mozilla Firefox®, or Opera®. The application 305 may be configured to display content formatted according to an HTML, Extensible Markup Language (XML), and/or another standard. Alternatively, the interface 300 could be implemented using another markup language (e.g., portable Document Format (PDF) or the like) adapted for display in another type of application.

The navigation component 307 may be used to enter a URI to access a website (e.g., server computer 208 of FIG. 2) and/or to navigate within a website. As discussed above, the opinion game may be provided as a component of a website (e.g., one or more webpages and/or web accessible content hosted on a website).

The display 310 may be configured to present HTML data to a user. The interface of the rating comparison interface 300 may be presented in the display 310 and may comprise rating comparison controls 309, a content item display 315, content item rating inputs 317 and 319, a content item title 320, a content item title rating input 322, a content item caption text 325, a content item caption text rating input 327, a technique/authoring description text 330, a technique/authoring description text rating input 332, content item metadata keywords 340, content item metadata keyword rating inputs 342, and a rating summary 350.

As discussed above, the content item presented in the display 315 may comprise various content types (e.g., imagery, video, audio, text, and so on). As such, a content item may be displayed in various ways and/or using various display components. For example, the display 315 may include an audio player component adapted to play audio content, may include a video player component adapted to display video content, a Flash® interface adapted to present a Flash® application, and so on.

The interface 300 may include one or more rating inputs 317, 319 adapted to receive user-submitted ratings of the content item displayed therein. Each of the rating inputs 317, 319 may comprise a title 317A, 317B, which may specify a particular rating category or aspect. For example, the rating input 317 may be configured to receive a “subject appeal” rating, and the input 319 may be configured to receive a “technical merit” rating. The rating input titles 317A and 317B may be assigned accordingly. The rating categories and/or aspects may be selected according to the nature of the content item presented in the display. For example, a text content item may include different rating categories than an audio content item, and so on.

The rating inputs 317 and 319 may include range indicators 317B, 317C and 319B, 319C, which may identify a range of the rating inputs 317 and 319 (“low” to “high”, “unappealing” to “appealing,” or the like). The range indicators may be adapted according to the rating category or aspect of the rating inputs 317 and 319.

Each of the rating inputs 317 and 319 may comprise a slider control to allow a user to enter a rating of the content item. However, other user inputs could be used under the teachings of this disclosure including, but not limited to: a selection box, a text input, a numerical input, or the like.

Although FIG. 3 depicts two (2) rating inputs 317 and 319, any number of rating inputs corresponding to any number of different rating categories and/or aspects could be included under the teachings of this disclosure. For instance, rating inputs could be provided to rate the “tonal qualities,” “beat,” “melody,” and the like of an audio content item. As such, this disclosure should not be read as limited to any particular number of rating inputs and/or rating categories or aspects.

In addition, although not shown in FIG. 3, the interface 300 may include an “overall” rating input used to provide a rating that is independent of any particular rating category or aspect.

The interface 300 may be configured to display metadata associated with the content item. The metadata may be used to describe the content item and/or categorize the content item. The FIG. 3 example includes a content item title 320, a content item caption 325, technique and authoring description 330, and metadata tags 340. However, other types metadata could be included under the teachings of this disclosure.

The interface 300 may include rating inputs adapted to receive ratings of the metadata 320, 325, 330, and/or 340. The content item title rating input 322 may be used to submit a rating of the content item title 320. The content item title rating 322 may allow the user to rate whether the content item title 320 provides an adequate description of the content item (e.g., whether the title is “helpful” or “non-helpful”). The rating input title 322A and range indicators 322B and 322C may be labeled accordingly.

The content item caption text 325 may be provided to allow an author of the content item (or some other user) to describe the content item displayed in the interface 300. For example, if the content item 315 were a photograph of a salmon, the caption may describe the location of the photograph (e.g., the river, season, and the like), the type of salmon photographed, and the like. A caption rating input 327 may be provided to receive a rating of the content item caption 325; the input 327 may include an appropriate title 327A, low range indicator 327B, and high range indicator 327C.

The technique/authoring text 330 may provide information describing how the content item was created and/or authored. For example, the content technique/authoring text 330 may describe how a photograph displayed in the interface 300 was created (e.g., identify the lens used, camera type, processing steps, and the like). A technique/authoring text rating input 332 may be provided to allow a user to rate the technique/authoring description text 330. The rating input 332 may comprise a title 332A (e.g., “technique description rating”), a low rating indicator 332B (e.g., “poor”), and a high rating indicator 332C (e.g., “excellent”).

The content item metadata tags 340 may comprise one or more metadata keywords (e.g., tags) applied to the content item by the author (or another user) to describe and/or categorize the content item. Each of the metadata keywords 340A-340D may have a corresponding rating input 342A-342D. The metadata keyword rating inputs 342A-342D may allow a user to rate the metadata keyword based on, for example, the relevance of the metadata keyword to the content item. Although not depicted in FIG. 3, each metadata keyword rating input 342A-342D may comprise a title (not shown), a low range indicator (not shown), and a high range indicator (not shown).

The rating comparison controls 309 may allow a user to control the operation of the interface 300 (e.g., opinion game) and may comprise a skip input 309A, a submit input 309B, an update input 309C, a more input 309D, and a quit input 309E. The skip input 309A may allow the user to skip the content item currently displayed in the interface 300 without submitting a rating of the content item and/or or the metadata 320, 325, 330, 340. The skip input 309A user may cause a new content item and associated metadata to be displayed in the interface 300.

The submit input 309B may cause the ratings entered into rating inputs 317, 319, 322, 327, 332, and 342A-342D to be submitted to a server. The ratings submitted through the interface 300 stored in a ratings database and may cause a rating summary to be presented in a display 350. The rating summary 350 is described in additional detail below.

The update 309C input may allow a user to update the rating summary 350 based on one or more descriptive tags entered via a tag input 352. The operation and contents of the rating summary 350 are described in more detail below.

The more input 309D may allow the user to access additional content authored by the author of the content item displayed in the interface 300. Selection of the input 309D may allow the user to access a gallery and/or collection of content submitted by the user-contributor. Alternatively, selection of the input 309D may cause another content item authored by the particular user to be presented in the interface 300.

The “quit” input 309E may cause the user to leave the rating comparison interface 300 and navigate to another interface, such as a user page, a home page, a portal, or the like.

The rating summary 350 may comprise comparison statistics showing a comparison of the ratings submitted by the user through the interface 300 to ratings submitted by other members of the user community. The comparisons displayed in the rating summary 350 may be tag-based (e.g., may be broken down based upon one or more descriptive tags of the community users as discussed above).

The rating summary 350 may display descriptive tags with which the user has shown some rating affinity. For example, the user may rate content items, and associated metadata 320, 325, 330, and 340 similarly to users having a tag of “artist.” The interface 300 may suggest in the rating summary 350 that the user should apply a an “artist” descriptive tag to his/her user account explore his/her affinity with other users of the site having an “artist” tag. If the user has not registered an account, the user may be prompted to do so, to allow the affinity information to be persisted and accessed during subsequent accesses to the website.

The update input 309C may be used to update and/or create a user account with one or more descriptive tags. The tags may be identified within the rating summary 350 and/or may be manually entered by the user. In some embodiments, at initial user registration, the rating summary 350 may not display suggested descriptive tags to avoid influencing the user in the selection of his/her tags.

The rating summary 350 may include a tag input 352. The tag input 352 may allow the user to supply one or more descriptive tags to perform tag-specific rating comparisons as described above. A user may input one or more tags into the tag input 352. The rating summary 350 may then be updated to show a tag-specific comparison between the ratings submitted by the user and the ratings of community users having the specified tags. In some embodiments, the interface 300 may suggest one or more tags for a tag-specific comparison. The suggested tags may be popular tags, tags with which the user has shown a rating affinity, tags selected from users that themselves share other tags with the user, and so on.

The tag input 352 may be configured to receive combinations of tags. In some embodiments, the tag input 352 may be adapted to interpret logical operators. Accordingly, a user may perform a tag-specific comparison with users having a “young” tag and an “artist” tag, and do not have a “liberal” tag (e.g., “young” AND “artist” NOT “liberal”).

In some embodiments, one or more tag combinations may be preselected for the user in the tag input 352 (e.g., in a selection box interface, or the like). The preselected tag combinations may correspond to cohesive tag groups described above. The user may select a predefined tag group to determine whether the user has a similar rating philosophy to members of the group. Selection of a tag group may cause the tag input 352 to be populated with the tags that define the tag group. The rating summary may then be updated to compare the user submitted ratings with the ratings submitted by the members of the tag group (as defined by the descriptive tags of the user community).

In some embodiments, the rating summary 350 may display a summary of a plurality of rating comparisons. For example, if the user had rated ten content items via the interface 300, the rating summary 350 could be adapted to include a summary of a comparison between the ten user-submitted ratings and corresponding ratings by other community users. The display may include various statistical comparisons, such as a mean difference between the ratings, variance, and so on. The comparisons may allow a user to distinguish between a transient and consistent ratings correlation. For example, the user may discover that while he/she rated a particular content item similarly to a certain set of users, other ratings are significantly different. Alternatively, the user may discover a consistent rating correlation with users having a particular set of descriptive tags.

Comparisons between user submitted ratings and the ratings of a tag group (e.g., a group of users that share a particular set of descriptive tags) may be performed within the interface 300. For example, if tags corresponding to a tag group are specified within the tag input 352 (or a particular tag group is specified as described above), the correlation between the ratings submitted by the user and a correlation within the group itself may be compared. As discussed above, the cohesiveness of a tag group may be quantified by comparing the ratings of the members of the group to one another. The comparison may be statistical and may comprise calculating a standard deviation and/or variance within the group (or other metrics according the technique used to model the group ratings). The correlation between user submitted ratings and a set of tag group ratings may be similarly quantified. For example, a plurality of ratings submitted by the user may be compared to corresponding ratings submitted by the members of the tag group (e.g., each user-submitted rating may be compared to a mean or average rating derived from the ratings submitted by members of the tag group). A standard deviation and/or variance (or other metric) between the user-submitted ratings and the ratings of the tag group constituents may be determined. The comparison may illustrate a ratings correlation (or lack thereof) between the user and the tag group. The correlation between the user and the tag group may be compared to the cohesiveness within the tag group itself. For example, the standard deviation and/or variance between the user and group may be compared to the standard deviation and/or variance within the group. If the user is at least as correlated to the group as the group itself, the user may be identified as a potential candidate for inclusion in the tag group. As such, the interface 300 may display an indicator suggesting that the user add the descriptive tags that define the tag group. If there is significantly less correlation between the user and the tag group, the user may be so informed and/or may be dissuaded from applying the group tags to his/her profile.

In some embodiments, the interface 300 may allow a user to add, edit, and/or remove descriptive tags to his/her user account. For example, selection of the update input 309C may cause the tags entered in the tag input 352 to be applied to the user account. Alternatively, tags removed from the tag input 352 may be removed from the user account, and so on.

In some embodiments, the rating summary 350 may comprise a graphical comparison display, such as a plot of a distribution or histogram of ratings submitted by community users. The plot may graphically illustrate various rating comparisons. The comparisons may be related to a single rating comparison and/or a plurality or sequence of rating comparisons.

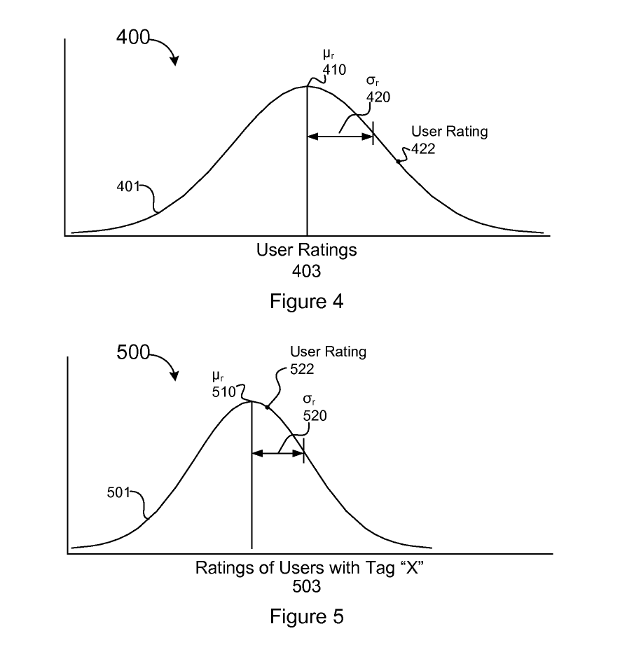

FIG. 4 shows one example of a graphical depiction 400 of a rating comparison. The graphical depiction 400 could be included in the interface 300 (e.g., within the rating summary 350). User-submitted ratings may be modeled using any number of modeling techniques and/or methodologies, including statistical methods. In the FIG. 4 example, a set of user community ratings may be modeled as a Normal distribution 401. The Normal distribution 401 may include a rating mean μᵣ 410 and standard deviation σᵣ 420. A user rating 422 may be displayed on the distribution 401 to provide a quick, easy-to-digest indication of the user's rating 422 relative to other members of the user community. Although FIG. 4 shows a graphical depiction of a rating comparison using a Normal distribution, one skilled in the art would recognize that any number of graphical techniques, plots, graphs, and the like could be used to compare ratings under the teachings of this disclosure.

The ratings depicted in the Normal distribution 401 may include ratings submitted by an entire user community and/or may consist of ratings submitted by a subset of the user community. For example, the Normal distribution 401 may include only those ratings submitted by users having a “young” tag or the like. Similarly, the Normal distribution 401 may include ratings of the members of a particular tag group (e.g., users having “young,” “artist,” and “urban” tags).

The Normal distribution 401 may correspond to a single rating comparison and/or may correspond to a plurality of rating comparisons as described above. In some embodiments, the depiction 400 may include labeling specifying various aspects of the comparison. For instance, in the FIG. 4 example, a label could be provided indicating that the user rating 422 is outside of the standard deviation σᵣ 420 of the user ratings 403. The label may specify that this indicates that the user is not particularly well correlated with the other user ratings 403.

FIG. 5 shows one example of a graphical depiction 500 of a tag-specific rating comparison. User-submitted ratings used to form the distribution 501 may correspond to users who have a particular descriptive tag “X” 503. Alternatively, or in addition, the user tag 503 could include a combination of tags, a logical combination of tags (e.g., “X” AND “Y” NOT “Z”), and/or a tag group.

Limiting the user ratings in this manner may change the nature of the distribution 501 compared to the user community as a whole (e.g., distribution 401 of FIG. 4). For example, the rating mean μᵣ 510 may be shifted relative to the mean 410, and the standard deviation σᵣ 520 may be narrower than the corresponding 420 deviation. This may indicate that users having the descriptive tag “X” comprise a more cohesive group than the general user community with respect to the rating of one or more content items. The user rating 522 may be plotted relative to the subset of the user community (e.g., users who have the descriptive “X” tag applied thereto). The relative location of the user rating 522 may indicate whether the user rated the content item and/or content item metadata similarly to other users in the sub-community. As shown in FIG. 5, the user rating 522 falls within a standard deviation deviation σᵣ 520 of the rating mean μᵣ 510 of the user ratings 503 and, as such, the user may be considered to be highly correlated with the ratings 503.

The ratings depicted in FIG. 5 may correspond to a single rating and/or may be derived from ratings of a plurality of content items and/or metadata. As described above, the depiction 500 could include labeling indicating various aspects of the comparison. For instance, a label indicating the high degree of correlation between the user rating 522 and the user ratings 503 could be provided.

As described above, the user ratings 503 could correspond to a tag group. The depiction 500 shows a correlation of the user rating 522 relative to the cohesiveness of the tag group. Since the user rating 522 (or series of user ratings 522) falls within the standard deviation of the tag group, the user may be identified as a good candidate for inclusion in the tag group.

Although FIG. 4 and FIG. 5 depict only a single graphical rating comparison, one skilled in the art would recognize that any number of graphical comparisons could be simultaneously and/or consecutively displayed under the teachings of this disclosure. For example, each of the rating inputs depicted on FIG. 3 may be associated with a graphical rating comparison (e.g., a graphical comparison of the content ratings 317, 319 and/or metadata ratings 322, 327, 332, and 342A-342D). In addition, a composite rating comparison comprising an average and/or weighted combination of the user ratings may be presented.

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps or by a combination of hardware, software, and/or firmware.

Embodiments may also be provided as a computer program product including a computer-readable medium having stored thereon instructions that may be used to program a computer (or other electronic device) to perform processes described herein. The computer-readable medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc. that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

It will be understood by those having skill in the art that many changes may be made to the details of the above-described embodiments without departing from the underlying principles of the invention. The scope of the present invention should, therefore, be determined only by the following claims.

We claim:

1. A computer-readable storage medium comprising instructions to cause a computing device to perform a method for comparing a rating to ratings in a user community, at least a subset of the users in the user community being associated with respective tags describing the users, the method comprising:
receiving from a first user a rating of an item;
receiving a specification of one or more tags from the first user;
identifying a subset of the user community based upon the specified tags;
comparing the rating submitted by the first user to one or more ratings of the item submitted by the users in the identified subset; and
providing an interface to display a result of the comparison between the rating submitted by the first user and the ratings submitted by the users in the identified subset.

2. The computer-readable storage medium of claim 1, wherein receiving the specification of the one or more tags comprises accessing tags associated with the first user.

3. The computer-readable storage medium of claim 1, wherein the identified subset consists of users within the user community associated with the specified tags.

4. The computer-readable storage medium of claim 1, wherein the identified subset consists of users within the user community that are not associated with the specified tags.

5. The computer-readable storage medium of claim 1, wherein the identified subset consists of users within the user community that are associated with a first one of the specified tags and are not associated with a second one of the specified tags.

6. The computer-readable storage medium of claim 1, wherein the comparison is between the rating submitted by the first user and an average of two or more ratings submitted by users in the identified subset.

7. The computer-readable storage medium of claim 1, wherein the comparison is a statistical comparison comprising a comparison of one or more statistical properties of the ratings submitted by the users in the identified subset to the rating submitted by the first user.

8. The computer-readable storage medium of claim 7, wherein the one or more statistical properties comprise a rating mean and a rating deviation.

9. The computer-readable storage medium of claim 1, wherein the comparison is displayed in a graphic, and wherein the graphic comprises a plot of the ratings of the subset of the user community, and wherein the plot comprises an indication of the rating submitted by the first user.

10. The computer-readable storage medium of claim 1, further comprising:
receiving plurality of ratings from the first user, each rating of a different item; and
comparing each of the ratings submitted by the first user to ratings of the respective items submitted by the users in the identified subset.

11. The computer-readable storage medium of claim 1, further comprising:
identifying one or more potential tags for the first user based on the rating submitted by the first user and ratings of the item submitted by the users in the user community.

12. The computer-readable storage medium of claim 11, wherein the potential tags are selected from tags associated with users in the user community that submitted ratings within a threshold of the rating submitted by the first user.

13. The computer-readable storage medium of claim 11, further comprising receiving a plurality of ratings from the first user, each rating of a different item, wherein the potential tags are identified based on the plurality of ratings submitted by the first user and the ratings of the user community.

14. The computer-readable storage medium of claim 1, wherein the interface displays a comparison between the rating submitted by the first user and ratings submitted by the user community as a whole.

15. A system for comparing user-submitted ratings to ratings of a user community, at least a subset of the users in the user community being associated with respective tags describing the users, comprising:
a computing device comprising a processor; and
a content management module operable on the processor and configured to receive from a first user a rating of an item and a specification of one or more tags;
a user management module operable on the processor and communicatively coupled to the content management module, the user management module configured to identify a subset of the user community based upon the specified tags and to compare the rating submitted by the first user to one or more ratings of the item submitted by users in the identified subset,
wherein the computing device is configured to provide an interface to display a result of the comparison between the rating submitted by the first user and the ratings submitted by the users in the identified subset.

16. The system of claim 15, wherein the specification of the one or more tags are tags associated with the first user.

17. The system of claim 15, wherein the identified subset consists of users within the user community associated with the specified tags.

18. The system of claim 15, wherein the identified subset consists of users within the user community that are not associated with the specified tags.

19. The system of claim 15, wherein the identified subset consists of users within the user community that are associated with a first one of the specified tags and are not associated with a second one of the specified tags.

20. The system of claim 15, wherein the comparison is between the rating submitted by the first user and an average of two or more ratings submitted by users in the identified subset.

21. The system of claim 15, wherein the comparison is a statistical comparison comprising a comparison of one or more statistical properties of the ratings submitted by the users in the identified subset to the rating submitted by the first user.

22. The system of claim 21, wherein the one or more statistical properties comprise a rating mean and a rating deviation.

23. The system of claim 15, wherein the comparison is displayed in a graphic, and wherein the graphic comprises a plot of the ratings of the subset of the user community, and wherein the plot comprises an indication of the rating submitted by the first user.

24. The computer-readable storage medium of claim 15, wherein the content management module is configured to receive a plurality of ratings from the first user, each rating of a different item, and
wherein the user management module is configured to compare each of the ratings submitted by the first user to ratings of the respective items submitted by the users in the identified subset.

25. The system of claim 15, wherein the user management module is configured to identify one or more potential tags for the first user based on the rating submitted by the first user and ratings of the item submitted by the users in the user community.

26. The system of claim 25, wherein the potential tags are selected from tags associated with users in the user community that submitted ratings within a threshold of the rating submitted by the first user.

27. The system of claim 25, further comprising receiving from the first user a plurality of ratings, each rating of a different item, wherein the potential tags are identified based on the plurality of ratings submitted by the first user and the ratings of the user community.

28. The system of claim 15, wherein the interface displays a comparison between the rating submitted by the first user and ratings submitted by the user community as a whole.

29. A computer-implemented method for comparing ratings in a user community, at least a subset of the users in the user community being associated with respective tags describing the users, the method comprising:
receiving from a first user a rating of an item;
receiving a specification of one or more tags from the first user;
identifying a subset of the user community based upon the specified tags;
comparing the rating submitted by the first user to one or more ratings of the item submitted by the users in the identified subset;
comparing the rating submitted by the first user to one or more ratings of the item submitted by the users in the user community as a whole; and
providing an interface to display,
a result of the comparison between the rating submitted by the first user and the ratings submitted by the users in the identified subset, and
a result of the comparison between the rating submitted by the first user and the ratings submitted by the users in the user community as a whole.

30. A computer-readable storage medium comprising instructions to cause a computing device to perform a method for identifying content for users in a user community, at least a subset of the users in the user community being associated with respective tags describing the users, the method comprising:
defining a plurality of tag groups comprising respective subsets of users in the user community based upon descriptive tags of the plurality of users;
selecting a cohesive tag group in the plurality of tag groups based upon ratings submitted by the users in the respective tag groups; and
identifying content for a user in the cohesive tag group based upon ratings submitted by the users in the cohesive tag group.
